(19) United States
(12) Patent Application Publication
(10) Pub. No.: US 2006/0151511 A1
(43) Pub. Date: Jul. 13, 2006

(54) Suction cup lid

(75) Inventor: Sascha Kaposi, Tacoma, WA (US)

Correspondence Address: BLACK LOWE & GRAHAM, PLLC, 701 FIFTH AVENUE, SUITE 4800, SEATTLE, WA, 98104, US

(73) Assignee: Progressive International Corp.

(21) Appl. No.: 11/130,910

(22) Filed: May 17, 2005

Related U.S. Application Data
(60) Provisional application No. 60/642,018, filed on Jan. 7, 2005.

(51) Int. Cl. B65D 43/04; A47J 37/01

(52) U.S. Cl. 220/805; 220/912; 220/573.1; 220/801

(57) ABSTRACT

A lid for a container, preferably integrally formed of silicone, or other flexible materials, and forming a convex, hemispherical, or other bulged shape. In some embodiments, a central handle or knob allows the lid to be grasped for placement over the container or for removal. When placed atop a container, the handle can be pressed downward, causing the convex shape to be reduced, or to be converted to a concave shape. The downward movement expels much of the air within the container, creating a relative vacuum so that the lid is held firmly in place. The suction force creates a tight seal between the lid and the vessel, aiding in maintaining the freshness of the item stored inside the container

### PRIORITY CLAIM

This application claims the benefit of prior provisional application Ser. No. 60/642,018, filed Jan. 7, 2005.

### BACKGROUND OF THE INVENTION

When preparing food, it is often necessary to store the food in a container for later use. For example, an ingredient may be prepared in part and may require refrigeration before the recipe can proceed. Likewise, leftover foods may be stored in a container and saved in a refrigerator or other location.

In many cases, the container that is used to store the food item may not have a lid, or may have a lid that does not produce a sufficient seal. For example, many glass or metal bowls used in cooking do not have lids at all. When preparing a food item to be stored in such a bowl, the only options are to leave the bowl uncovered or to use a plastic wrap. Likewise, most cookpots have lids, but the lids do not produce an airtight seal. Storing foods in such pots is undesirable because of the inefficiency of the seal.

There is therefore a need for an improved lid that is capable of producing a relatively airtight seal when used with a variety of containers of a range of sizes, including cooking bowls and pots that either do not have lids or that have lids that cannot produce a desired seal.

### SUMMARY OF THE INVENTION

The present invention generally comprises a lid for a container. In the preferred form, the lid is highly flexible, and forms a convex, hemispherical, or other bulged shape. In some embodiments, a central handle or knob allows the lid to be grasped for placement over the container or for removal. When placed atop a container, the handle can be pressed downward, causing the convex shape to be reduced, or to be converted to a concave shape. The downward movement expels much of the air within the container, creating a relative vacuum so that the lid is held firmly in place. The suction force creates a tight seal between the lid and the vessel, aiding in maintaining the freshness of the item stored inside the container.

### DESCRIPTION OF THE DRAWINGS

FIG. 1 is a side view of a preferred suction cup lid;

FIG. 2 is a top view of a preferred suction cup lid;

FIG. 3 is a cross-sectional view of a preferred suction cup lid, the cross-section being taken along line A-A in FIG. 1;

FIGS. 4A and 4B are side views of a preferred suction cup lid placed atop a container;

FIG. 5 is a perspective view of a preferred suction cup lid;

FIG. 6 is a perspective view of an alternate preferred suction cup lid;

FIG. 7 is a perspective view of an alternate preferred suction cup lid in use with a container; and

FIG. 8 is a cross-sectional view of a preferred suction cup lid in use with a plurality of containers.

### DETAILED DESCRIPTION OF THE PREFERRED EMBODIMENT

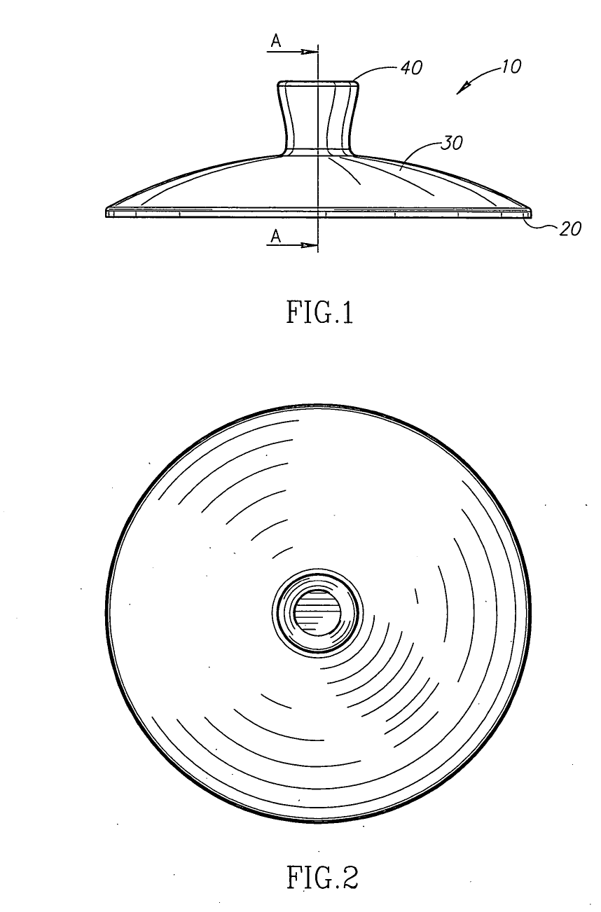

FIG. 1 illustrates a perspective view of a preferred suction cup lid. As shown, the lid 10 includes an outer rim or peripheral region 20, a central portion 30, and handle (in this case, in the form of a knob) 40. The lid of FIG. 1 has a generally circular perimeter, as shown in the top view of FIG. 2. Accordingly, the preferred lid is designed for covering a container having an upper rim that is also circular in shape, such as a bowl or a pot. As discussed further below, however, the lid can also be used on containers having openings that are not circular, and certain qualities of the lid make it ideally suited for use on containers having a wide variety of shapes.

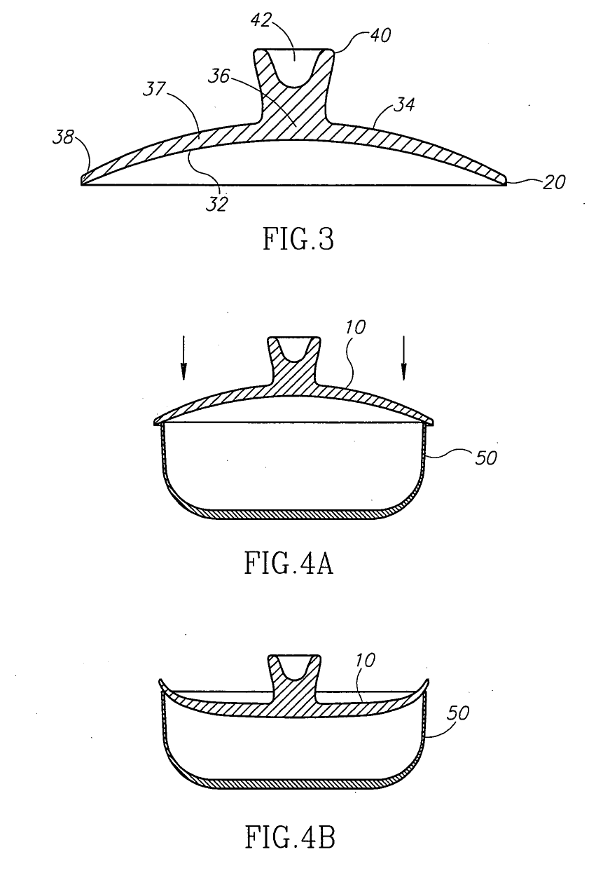

As best seen in the cross-sectional view of FIG. 3 (taken along line A-A of FIG. 1) and the perspective view of FIG. 5, the preferred lid has an upward curvature taken in the direction from the outer rim 20 toward the center of the lid. Ideally, the lid is formed in a molding process that gives the lid a natural bulged shape in its resting position. At the rim 20, the lid terminates in a slightly rounded edge. In alternative forms, the edges may include sharper corners.

There is no need for ridges and grooves in the preferred form of the invention. As such, the interior surface 32 of the lid is substantially smooth, particularly along the outer rim 20. The generally smooth surface will provide for a better contact between the lid and the container, resulting in a relatively airtight seal. In addition, the absence of such grooves and ridges helps to enable a single lid to be used with a number of different containers having a wide range of sizes.

The handle 40 preferably located at the center of the lid, at the outer surface 34. It is larger at the top than at the base, and is shaped and formed to allow a user's hand to easily grasp the lid and pull it upward for removal. Optionally, the handle 40 includes an interior hollow portion region forming a cavity 42 at the top of the knob. Alternative handles may include, for example, rings or other such configurations that may be readily grasped to remove the lid from a container. In another alternative, the handle may be in the form of a loop or tab extending from the perimeter of the lid.

The lid 10 is formed from flexible materials such as rubber, silicone or other suitable materials. Preferably, the material is one that will produce a flexible lid that can substantially retain its shape in the convex position as shown in FIGS. 1-3 when not in use with a container, but that can be readily converted to a concave position as described below. In addition, the material preferably has a relatively high coefficient of friction such as would be found in rubber or silicone, to enable a strong seal and reduce slipping at the interface between the lid and a container.

The shape-retaining function is also advanced by the thickness of the lid. As noted above, the lid is preferably molded or otherwise formed at the time of manufacture such that its natural position is somewhat bulged. One advantageous feature of the preferred embodiment, however, is to allow some flexibility of the lid around the perimeter so that a suction function is created, while retaining a measure of stiffness within the lid so that it does not simply fall into the container. At the center or central region 36, the lid is formed of a sufficient thickness such that a moderate force is required to deform that portion of the lid. The thickness at the central portion may be characterized as semi-rigid. At the peripheral region, the cross-sectional thickness is much smaller than that of the center of the lid, making the perimeter much more flexible. In the preferred form, the peripheral region is flexible, preferably such that it deforms under its own weight. In the intermediate region 37 between the center and the perimeter, the lid has an intermediate thickness and corresponding rigidity.

As shown in FIGS. 4A and 4B, the lid is placed at the upper end of a container such as a bowl or a pot in order to seal it. Because of the manner in which the lid is used to seal the container, a single suction cup lid in accordance with the invention can be used with containers of a relatively wide array of sizes. In general, so long as the diameter of the container is less than the diameter of the lid, the lid can be used to cover the container and produce a relatively airtight seal.

To seal a container, the lid is placed atop the container 50, as shown in FIG. 4A. By grasping the knob 40 and pressing downward, the outer rim of the lid is urged upward and the flexible nature of the lid allows the convex form of the lid to be inverted into a concave shape, as shown in FIG. 4B. In addition, the lid itself is forced downward into the container somewhat. As the lid is pressed into a concave shape, air within the container is expelled around the perimeter of the lid, creating an effective seal between the lid and the interior of the container.

In order to remove the lid, an edge of the lid is lifted, pulling the edge away from the interior surface of the container. Pulling the edge of the lid away from the container allows air to flow into the container, equalizing the pressure inside and outside the container and releasing the seal. With the seal released, the lid can be removed by pulling it upward, using the knob, an edge of the lid, or both.

In addition to the sealing benefits of the lid described above, the lid is advantageous because it may be used with a variety of containers such as bowls and pots that do not have their own lids or that have lids that do not produce an airtight seal. Glass or metal cooking bowls commonly do not have lids associated with them. The lid of the present invention can be readily used with all such bowls. Likewise, cooking pots often have lids but the provided lids are loosely fitting and do not produce an airtight seal. Accordingly, the lid of the present invention can be readily used with pots to better store food because of the improved seal. Similarly, an appropriately sized lid in accordance with this invention can be used to seal opened food cans, including pet food cans.

An additional advantage of the lid is that it is self-venting. When foods are cooked, for example in a microwave oven, the cooking process typically releases steam. If the food is cooked in a container having an airtight lid, the trapped steam exerts an increasing force on the lid that will eventually force the lid from the container, splattering food within the oven in the process. Consequently, a typical lid must be removed entirely or slightly in order to provide a vent for steam to escape.

The lid of the present invention makes removal or venting of the lid unnecessary. As shown, for example, in FIG. 4B, steam trapped within the container 50 will exert an upward force on the lid 10. When the force exerted by the steam is sufficiently strong, it will cause a slight separation at the interface between the lid 10 and container 50, as indicated by the arrows in FIG. 4A. Once a sufficient amount of steam has escaped to equalize the pressure, the lid will collapse again to the side of the container, maintaining full coverage.

Because of this self-venting feature, a lid in accordance with the present invention can be used with a container to store foods in a refrigerator, allowing the container to be transferred from the refrigerator or freezer to the microwave oven, conventional oven, or stovetop without adjusting the lid in any way to allow steam to vent.

In the preferred embodiment, the lid is shown as being generally circular and used with a container that also has a circular rim. The lid may be any shape, however. For example, it may be square, rectangular, or oval for use with containers of a similar shape. In addition, the flexible nature of the lid enables it to be used with a container having a shape that differs from that of the lid. For example, a circular lid can be used with a square container because the lid will conform itself to the shape of the container.

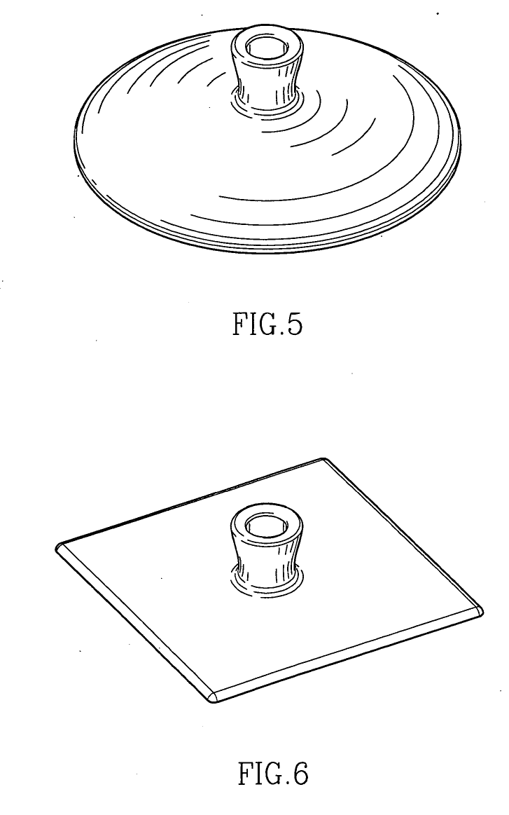

An example of a substantially square lid is shown in FIG. 6. The lid of FIG. 6 can be used with a container having a rectangular opening of a similar size. In addition, because of the flexibility of the materials used in making the lid, it can also work when used with a container that has a circular opening

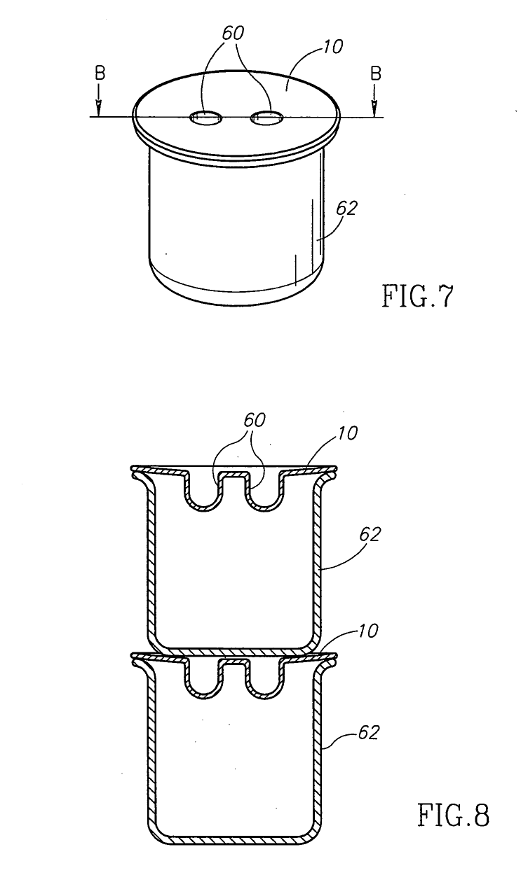

As shown in FIGS. 7-8, an alternate construction is provided in which a plurality of lids is used with an equal number of containers 62. The lids of FIGS. 7-8 include an alternate gripping portion, instead of the knob of FIG. 1. In this alternate embodiment, the grip comprises a pair of concavities 60 sized and shaped to allow a user to grip the lid by inserting one finger and a thumb, respectively, into each concavity and then pulling up on the lid 10. This alternate embodiment is useful in certain situations in that it enables multiple containers and lids to be easily stacked without having the knob interfering with the stacking.

I claim:

1. A lid, comprising:
a peripheral region, a central region, and an intermediate region between the central region and the peripheral region, the lid being integrally formed of silicone material, wherein at least the peripheral region is flexible; and
a grip located on an upper surface of the lid.

2. The lid of claim 1, wherein the peripheral region is sufficiently flexible that it deforms under the weight of the lid.

3. The lid of claim 1, wherein the central region of the lid is bulged upward relative to the peripheral region.

4. The lid of claim 1, wherein a cross-section of the lid taken through a diameter has a thickness, the thickness at the peripheral region being less than the thickness at the central region.

5. The lid of claim 4, wherein the thickness of the lid at the intermediate region is less than the thickness at the central region and greater than the thickness at the peripheral region.

6. The lid of claim 1, wherein the grip comprises a knob.

7. The lid of claim 1, wherein the grip comprises a pair of concavities within an upper surface of the central region of the lid.

8. The lid of claim 1, further comprising a lower surface, the lower surface being substantially devoid of channels or grooves.

9. The lid of claim 1, further comprising a lower surface, the lower surface being substantially smooth.

10. The lid of claim 1, further comprising a peripheral shape, wherein the peripheral shape is generally circular.

11. The lid of claim 1, further comprising a peripheral shape, wherein the peripheral shape is substantially rectangular.

12. The lid of claim 1, wherein the lid is formed such that the central region is bulged upward, and the peripheral region is sufficiently flexible that it deforms under the weight of the lid.

13. A method for covering a container, comprising:
placing a lid over the container, the lid having a peripheral region, a central region, and an intermediate region between the central region and the peripheral region, the lid being integrally formed of silicone material, wherein at least the peripheral region is flexible, the lid further having a grip located on an upper surface of the lid; and
depressing an upper surface of the lid.

14. The method of claim 13, wherein the peripheral region is sufficiently flexible that it deforms under the weight of the lid.

15. The method of claim 13, wherein the lid further comprises a natural state in which the central region is bulged upward relative to the peripheral region, and further wherein the step of depressing the upper surface of the lid reduces the extent to which the lid is bulged upward.

16. The lid of claim 13, wherein a cross-section of the lid taken through a diameter has a thickness, the thickness at the peripheral region being less than the thickness at the central region.

17. The lid of claim 16, wherein the thickness of the lid at the intermediate region is less than the thickness at the central region and greater than the thickness at the peripheral region.

18. The lid of claim 13, wherein the lid further comprises a knob, and further wherein the step of depressing the lid comprises grasping the knob.

19. The lid of claim 13, wherein the lid further comprises a pair of concavities on an upper surface of the lid.

20. The lid of claim 13, further comprising a lower surface, the lower surface being substantially devoid of channels or grooves.

21. The lid of claim 13, further comprising a lower surface, the lower surface being substantially smooth.

22. The lid of claim 13, further comprising a peripheral shape, wherein the peripheral shape is generally circular.

23. The lid of claim 13, further comprising a peripheral shape, wherein the peripheral shape is substantially rectangular.

24. The lid of claim 13, wherein the lid is formed such that the central region is bulged upward, and the peripheral region is sufficiently flexible that it deforms under the weight of the lid.
